(19) United States
(12) Patent Application Publication
(10) Pub. No.: US 2023/0385218 A1
(43) Pub. Date: Nov. 30, 2023

(54) USB TYPE-C SUBSYSTEM

(71) Applicant: Intel Corporation, Santa Clara, CA (US)

(72) Inventors: Udaya Natarajan, El Dorado Hills, CA (US); Kannappan Rajaraman, Bangalore (IN); Huimin Chen, Beaverton, OR (US)

(21) Appl. No.: 17/826,933

(22) Filed: May 27, 2022

(51) Int. Cl. G06F 13/38; G06F 13/42

(52) U.S. Cl. CPC G06F 13/382; G06F 13/4282; G06F 2213/0042; G06F 2213/3812

(57) ABSTRACT

Embodiments herein relate to a universal serial bus (USB) host system that is configured to perform port orientation identification and/or configuration lane identification. Specifically, the USB host system may include a USB Type-C port configured to communicate in accordance with the USB 3.2 protocol. The described identifications may be performed without the use of a power delivery (PD) and/or Type-C port controller (TCPC) module. Other embodiments may be described and claimed.

### FIELD

The present application generally relates to the field of electronic circuits and, more specifically, to a universal serial bus (USB) host and associated apparatuses, systems, and methods.

### BACKGROUND

Computer and electronic handheld devices may have USB Type-C ports. A Type-C port may be a port that supports USB 3.2, USB 4, and/or some other I/O protocols such as Thunderbolt and DisplayPort. Generally, USB 3.2 may be a USB protocol that supports 2 data lanes on a Type-C connector, thereby increasing the aggregate bandwidth of the link to up to 20 Gigabits per second (Gbps).

For a Type C port to support multiple I/O protocols, it is required to implement a Power Delivery protocol to negotiate I/O protocols that are not USB 3.2. Power delivery protocol, as its name implies, may also support power delivery either as a power source to charge a connected device, or as a power sink to be charged from a connected device. In addition, a Type C port state machine based on USB Type C specification may also be required to implement functions such as orientation detection, Host or device role negotiation, audio accessory, or debug. A legacy Type-C port implementation may require a power delivery (PD) and/or Type-C port controller (TCPC) module to support the above mentioned functions and capabilities. Device layout and/or power distribution to these components may incur additional cost and/or power consumption.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates an example system with a PD/TCPC-less USB 3.2 host, in accordance with various embodiments.

FIG. 2 illustrates an alternative example of a system with a PD/TCPC-less USB 3.2 host, in accordance with various embodiments.

FIG. 3 illustrates an alternative example of a system with a PD/TCPC-less USB 3.2 host, in accordance with various embodiments.

FIG. 4 illustrates examples of circuits that may be used in a PD/TCPC-less USB 3.2 host, in accordance with various embodiments.

FIG. 5 illustrates an alternative example of a system with a PD/TCPC-less USB 3.2 dual-role host or device SoC, in accordance with various embodiments.

FIG. 6 illustrates an example process to be performed by a USB 3.2 host, one or more elements of a USB host, and/or an electronic device that includes a USB host, in accordance with various embodiments.

FIG. 7 illustrates an example process to be performed by a USB 3.2 host, one or more elements of a USB host, and/or an electronic device that includes a USB host, in accordance with various embodiments.

FIG. 8 illustrates a smart device or a computer system or a System-on-Chip (SoC) with apparatus and/or software related to or including a USB 3.2 host, in accordance with some embodiments.

FIG. 9 illustrates an example process to be performed by a dual-role USB 3.2 host/device system, one or more elements of such a system, and/or an electronic device that includes such a system, in accordance with various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

As noted, legacy Type-C ports may require a PD and/or TCPC module to support multiple I/O protocols and power delivery towards a USB Type-C port. Device layout and/or power distribution to these components may incur additional cost and/or power consumption.

However, in some use cases such a PD or TCPC module may not be necessary. For example, some use cases (e.g., digital signage, low-cost, or walk-in ports) may not require the benefits provided by the PD and/or TCPC modules to USB hosts. Therefore, it may be desirable to enable USB Type-C ports to operate without such a PD and/or TCPC module.

Embodiments herein relate to a USB host that is configured to operate a Type-C port that supports USB 3.2 without the use of a PD and/or TCPC module. Specifically, embodiments herein relate to a USB 3.2 host that is configured to identify orientation of the plug in the Type-C port, and subsequent communication in accordance with the USB 3.2 protocol, without the use of a PD and/or TCPC module. In some embodiments, the SoC of the USB host may be an element of the port, while in other embodiments the SoC may be separate from, but communicatively coupled with, the port.

It will be understood that some embodiments may relate to or include a USB 3.2 host that is configured to communicate in accordance with a USB protocol using a PD and/or TCPC on one port, and communicate in accordance with a USB protocol without a PD and/or TCPC on another port. However, for the sake of clarity of discussion, embodiments herein will only be described as lacking the PD and/or TCPC.

Generally, as used herein, a USB Type-C port refers to a USB port that allows for a plug to be coupled with the port in different orientations (as opposed to, for example a Type-A USB port that only allows for the plug to be coupled with the port in a single orientation). Additionally, the USB Type-C port may include at least 2 data lanes and at least two communication channels (CCs).

Specifically, the USB 3.2 technology may support up to 2 data lanes capable of data transfer speeds of 10 Gbps each, thereby increasing the effective bandwidth of the USB 3.2 communication link to 20 Gbps. The additional lane may be delivered on the Type-C port as opposed to, for example, the Type-A port that only exposes one data lane. Additionally, the USB 3.2 VBUS default power specification for 2 lanes may be increased to approximately 1.5 Amps (A) to provide adequate power to devices to operate on both of the lanes.

Generally, in legacy USB hosts that include a PD and/or TCPC module, USB 3.2 protocol link setup negotiation may start with identification of a Configuration lane for initialization. The configuration lane may be one of the two data lanes, and which data lane it is may need to be identified between the two possible data lanes. Based on which data lane is identified as the configuration lane, the USB 3.2 host SoC may then identify the orientation of the USB cable in the USB port.

Typically, the Type C port state machine in the PD and/or TCPC module may identify the Configuration lane through the Type-C side band CC negotiation protocol. That is, the Type C port state machine in the PD and/or TCPC module may be coupled with the two CCs, and configured to identify the orientation of the USB cable in the USB port and, subsequently, the identification of the configuration lane.

After identifying the orientation of the cable, the PD and/or PCPC module may operate on the CC wire to negotiate the power delivery contract and I/O protocol if it is not USB 3.2. The Type C port state machine may update the USB host controller of the USB host, and provide an indication of which data lane is the configuration lane.

However, as noted herein, in embodiments one or more of the PD/TCPC platform hardware components/modules, the Type C port state machine in the PD and/or TCPC module, and the associated firmware may be replaced with an interrupt to the USB host controller in the SoC, in one embodiment, the utilization of the USB input/output (I/O) physical layer (PHY) Rx.Detect circuit on both of the data lanes to identify which lane is a configuration lane. In another embodiment, a voltage change on one of the CC lanes may be monitored for, and subsequently identified, in order to identify which data lane should be the configuration lane.

### Rx.Detect-Related Technique

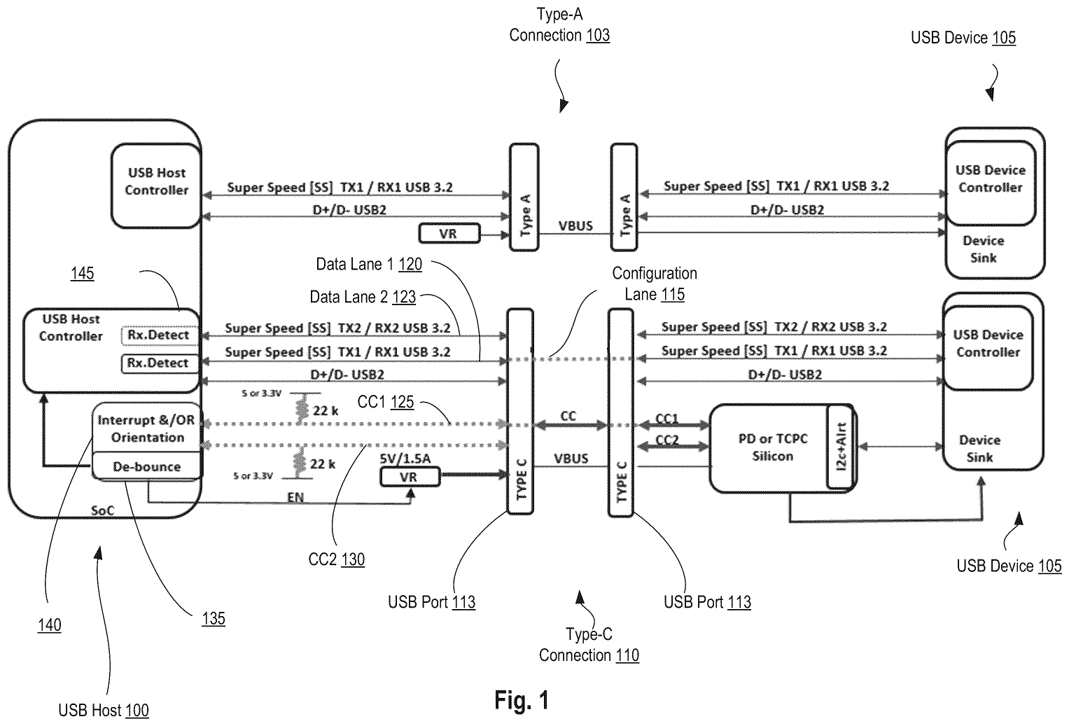

FIG. 1 illustrates an example system with a PD/TCPC-less USB 3.2 host, in accordance with various embodiments. Specifically, FIG. 1 depicts a USB host 100 that is coupled with a plurality of USB devices 105. The USB host 100 may be, for example, an electronic device such as a computer, a desktop computer, a laptop computer, a digital sign, a gaming device, and/or some other electronic device with which one or more USB devices may be coupled. The USB devices 105 may be or include, for example, a mobile phone, a peripheral (e.g., a dongle, a mouse, a keyboard, etc.), a battery charger pack, and/or some other USB device.

As may be seen in FIG. 1, the USB host 100 may be coupled with one of the USB devices 105 by a Type-A connection 103 and a Type-C connection 110 via Type-C USB ports 113. The Type-C connection 110 may include a plurality of data lanes 120 and 123 as well as a plurality of CCs 125 and 130.

The USBhost 100 may optionally further include a debounce/comparator module 135 and an interrupt/orientation module 140. The debounce/comparator module 135 may be implemented to filter out any electrical fluctuation during the period of device plug in. Additionally, the interrupt/orientation module 140 may be introduced to inform the USB host controller about the event of device plug-in and its orientation on the Type C port.

It will be noted that the diagram of FIG. 1 (and other subsequent Figures herein) is intended as a highly simplified diagram for the sake of discussion herein, and real-world embodiments would include additional modules, circuitry, connections, etc. Additionally, the specific configuration shown in FIG. 1 is intended as a simplified example for the purposes of discussion, but other configurations (e.g., the relative placement of different elements or modules) may vary in other embodiments. It will further be noted that element such as the modules 135/140, the depicted USB host controller 145, etc. may be implemented as hardware, firmware, software, and/or some combination thereof.

In embodiments, a USB Type-C connector pullup resistor may be exposed each on CC1 125 and CC2 130, as shown. Additionally, VBUS may always be enabled between the USB ports 113. It will be noted that neither the pullups or the VBUS are specifically labelled in FIG. 1 for the sake of lack of further clutter of the Figure, but will be recognized by one of skill in the art. Specifically, the pullup may refer to the connection to the voltage bus (e.g., the 5 Volt (V) or 3.3V bus), and VBUS is depicted and labelled as such.

The USB host controller 145 may set the receive (Rx) termination on both of the data lanes 120/123 to always-enabled, and perform Rx.Detect (e.g., far-end recerver termination detection) for determining the presence of a USB device 105. Specifically, the Rx.Detect procedure may be performed on both of data lanes 120 and 123. In some embodiments, the Rx.Detect procedure may be performed by the USB host controller 145 subsequent to a reset procedure of the USB host controller 145.

The Rx.Detect procedure may be performed in accordance with, for example, the “Universal Serial Bus 3.2 Specification,” Revision 1.0, September, 2017, as published by the USB 3.0 Promoter Group. Specifically, the Rx.Detect procedure may include producing a step function of a common mode voltage at a transmitter and monitoring the rise time (or time constant) of the step function in order to determine if a low-impedance termination of the device is present.

Because of the orientation of the USB device 105 may only expose a Rx termination on one of the data lanes 120/123, the Rx.Detect procedure will only be successful on one of the two data lanes 120/123. The USB host controller 145 may then infer, based on which of the two data lanes 120/123 the Rx.Detect procedure was successful on, that data lane 120/123 as the configuration lane 115 for use in accordance with the USB 3.2 protocol.

After identification of the configuration lane, the Rx termination on the non-configured lane may be removed by the USB host controller 145, and the USB host controller 145 may use the configuration lane for subsequent protocol state configurations.

### Voltage Change Technique

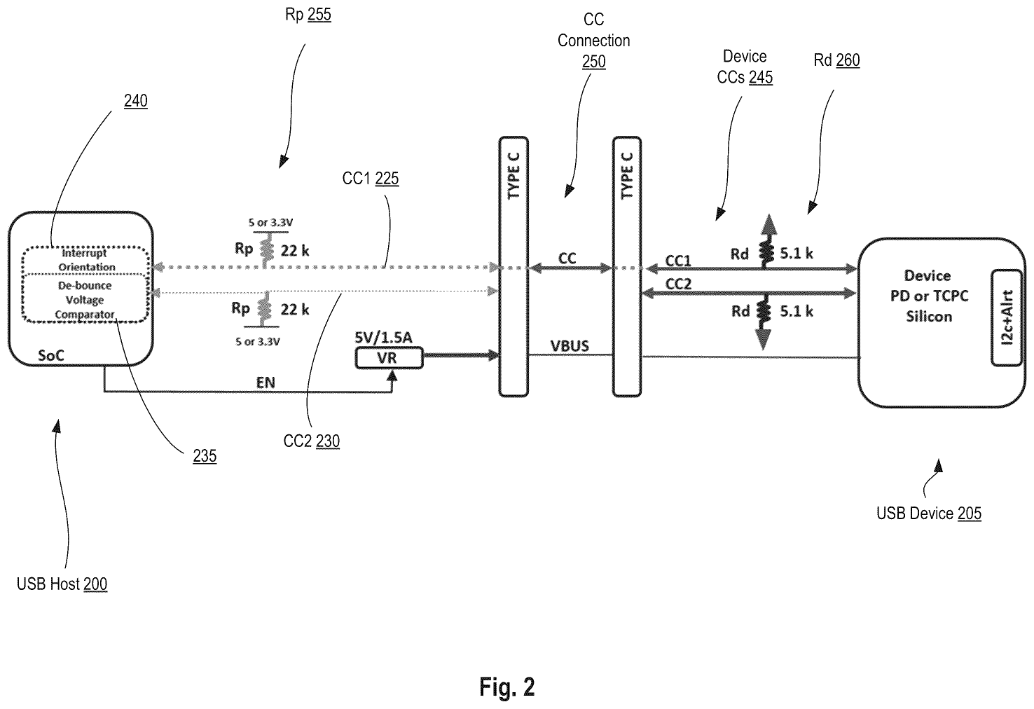

FIG. 2 illustrates an alternative example of a system with a PD/TCPC-less USB host, in accordance with various embodiments. The system of FIG. 2 may include elements similar to those of FIG. 1. Specifically, the system may include a USB host 200, USB device 205, CC1 225, CC2 230, and modules 235 and 240, which may be respectively similar to USB host 100, USB device 105, CC1 125, CC2 120, and modules 135/140. Other elements of FIG. 1 may likewise be present, but are not specifically enumerated for the sake of clarity of the Figure and subsequent discussion. As may be seen in FIG. 2 (and FIG. 1), the USB device 205 may be coupled with the Type-C port by device CCs 245 (e.g., CC1 and CC2).

In this technique, CC1 225 and CC2 230 may be wired to the USB host 200 from the Type-C port. When a USB device (e.g., USB device 205) is connected to the port (e.g., when a cable that is coupled with the USB device 205 is coupled to a port of the USB host 200), a voltage change may be identified. Specifically, as may be shown in FIG. 2, CC1 225 and CC2 230 may be coupled by resistors Rp 255 to a 5V or 3.3V voltage bus. Similarly, device-side resistors Rd 260 may couple the device CCs 245 to ground (although, it will be noted that in other embodiments the device CCs 245 may be coupled to a voltage bus and resistors Rp 255 may be coupled to ground, both resistors 255 and 260 may be coupled to a voltage bus with varying voltage, etc.).

As may be seen in FIG. 2, the voltage change may only be detected on one of CC1 225 and CC2 230. This may be because, based on the orientation of the plug in the USB port, a CC connection 250 may only be made between one of the Device CCs 245 and one of CC1 225 or CC2 230. Based on which of CC1 225 and CC2 230 the voltage change is identified, the orientation of the plug in the port may be identified and, subsequently, the configuration lane (e.g., configuration lane 115) may be identified as described with respect to FIG. 1.

In some embodiments, the USB host 200 and, specifically, the voltage comparator module 235, may compare the voltage change to a pre-identified voltage threshold. Such a comparison may be to ensure that minor power jitter in the system is not identified as a connection of a USB device 205. Additionally, in some embodiments, the voltage change may be identified against a time threshold to ensure that a brief voltage spike does not trigger identification of such a connection. The specific power threshold or time threshold may be pre-configured based on the power rail to which the Rp resistors 255 are coupled, power requirements of the USB host 200, the specific use case to which the USB host 200 will be put, etc. In other embodiments, such thresholds may be dynamic.

Subsequently, when the USB device 205 is detached, the CC1 225 or CC2 230 may identify the subsequent voltage change and alert the USB host 200 to perform a disconnect procedure.

### Further Enhancements

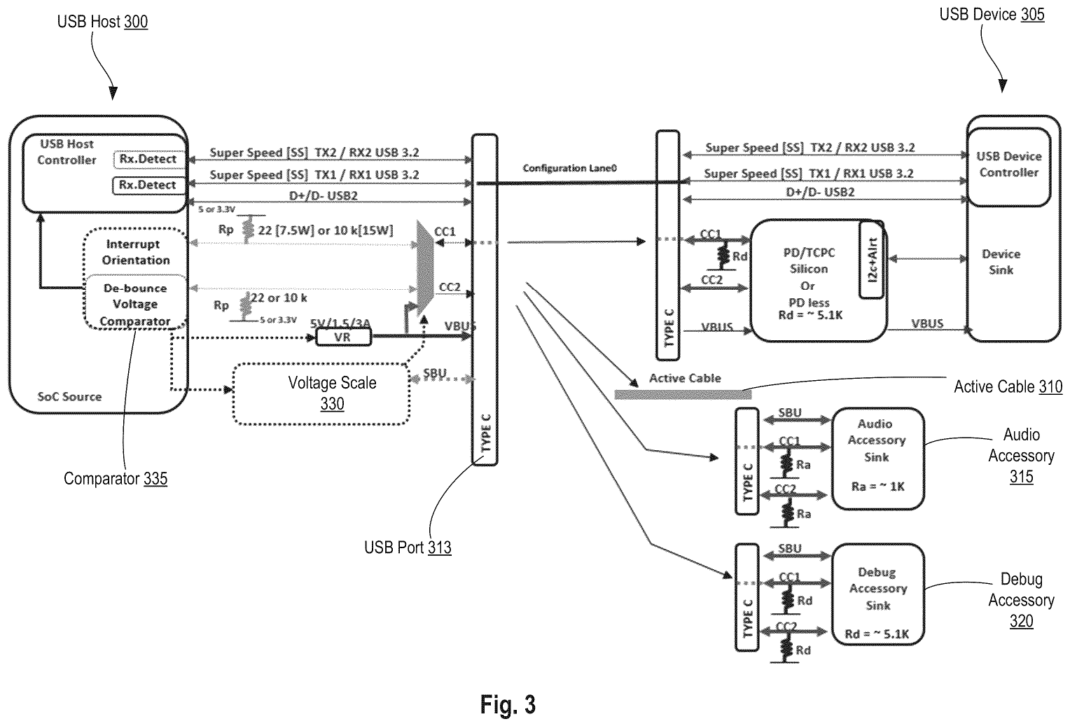

In some embodiments, it may be desirable for the USB host to be able to support active cables, a debug accessory, and/or an audio accessory without a PD/TCPC module in addition to coupling with a USB device 305. FIG. 3 depicts an example of a system able to support such functions. Specifically, FIG. 3 illustrates an alternative example of a system with a PD/TCPC-less USB host, in accordance with various embodiments.

Specifically, FIG. 3 depicts a USB host 300, which may be similar to USB host 100. The USB host may include a comparator module 335, which may be similar to module 135. It will be noted that the system may include several elements similar to those depicted in, or described with respect to, one of FIG. 1 or 2 (e.g., the data lanes, the CC lanes, etc.) However, such elements are not explicitly enumerated for the sake of clarity of the Figure.

As may be seen, the USB host may be coupled with USB device 305 (which may be similar to USB device 105). Alternatively, the USB host 300 may be coupled with an active cable 310 that is coupled with the port 313 (which may be similar to port 113). As used herein, an active cable may refer to a cable assembly that includes an active component such as a re-timer or re-driver. The function of the re-timer or re-driver is to boost the signal energy.

Alternatively, the USB host 300 may be coupled with an audio accessory 315. As used herein, an audio accessory may be an accessory that is configured to receive audio signals provided by the SoC source (e.g., the USB host 300). For example, an audio accessory may refer to headphones, a speaker, or some other type of audio device.

Alternatively, the USB host 300 may be coupled with a debug accessory 320. As used herein, a debug accessory may refer to an accessory that is able to transmit or receive one or more signals that may be used to debug the USB host 300, an element of the USB host 300, and/or an electronic device of which the USB host 300 is a part.

As may be suggested by the various descriptions of the USB device 305, the active cable 310, the audio accessory 315, and the debug accessory 320, it may be desirable for the USB host 300 to be able to identify which of the various elements is coupled to the USB host 300 so that it may operate appropriately. In some embodiments, this function may be achieved by the comparator module 335. Specifically, the comparator module 335 may be configured with voltage references (e.g., predefined identification of which voltage configurations on which of the various CC or data lanes) that indicate a specific device.

For example, as may be seen in FIG. 3, the CC lanes of USB device 305 may be coupled with a resistor Rd, which may have a value of approximately 5100 ohms. As noted, dependent on the orientation of the USB cable in the port of the USB host 300, only one of the CC lanes of the USB device 305 may be identified by the USB host 300.

Additionally, the CC lanes of the audio accessory 315 may be coupled with a resistor Ra, which may have a value of approximately 1000 ohms. Finally, CC lanes of the debug accessory 320 may also be coupled with resistor Rd. It will be noted that both of the CC lanes of the USB host 300 may identify the audio accessory 315 or debug accessory 320.

Based on the above, the comparator module 335 may be configured to identify (e.g., based on a voltage identified on the CC lanes of the USB host, which in turn would be based on the resistor that is coupled with the CC lanes of the device, cable, or various accessories), which of the various elements is coupled with the USB host. For example, if the voltage comparator 335 only identifies a value of Rd coupled with a single one of the CC lanes of the host 300, then the voltage comparator 335 may output a signal (e.g., to the USB host controller) that indicates the presence of a USB device 305, and the orientation of the cable in the USB port of the USB host 300. Similarly, if the voltage comparator 335 identifies Rd on both of the CC lanes of the USB host 300, then the voltage comparator 335 may identify that the debug accessory 320 is connected. Table 1 provides an example of the output that would be seen by the comparator, and the subsequent output of which element is present to the USB host controller of the USB host 300.

TABLE 1

| | |
|---|---|
| CC1 | CC2 |

| Rd | Ra | Rd | Ra | Comparator Output |
|---|---|---|---|---|
| 1 | 0 | 0 | 0 | USB device, first orientation |
| 0 | 0 | 1 | 0 | USB device, second orientation |
| 1 | 0 | 0 | 1 | Active Cable |
| 1 | 0 | 1 | 0 | Debug Accessory |
| 0 | 1 | 0 | 1 | Audio Accessory |

In some embodiments, it may be desirable to provide a voltage scaling module 330. The voltage scaling module may be used to scale or shift the voltage swings on the CC lines of the USB host 300. Such scaling may be useful for the identification of the audio accessory 315 or the debug accessory 320, which may have their own voltage sources (e.g., VCONN). The voltage scale 330 may be used to normalize the voltage identified by the voltage comparator 335 such that appropriate identification of Ra or Rd may be performed by the comparator 335.

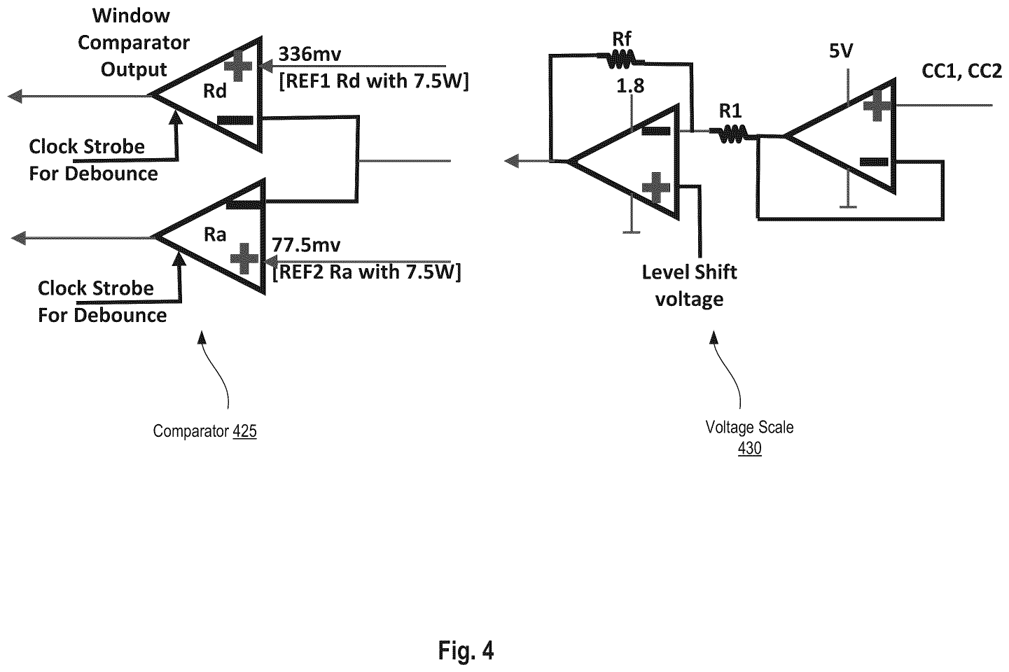

FIG. 4 provides simplified examples of circuits that may be used with the USB host 300 of FIG. 3, or some other USB host herein. Specifically, FIG. 4 depicts an example circuit at 425 that may function as the voltage comparator 335 to identify the presence of Rd or Ra on a given line. Additionally, FIG. 4 depicts an example circuit at 430 that may function as the voltage scale 330 of FIG. 3.

It will be noted that the specific circuit implementations of FIG. 4, or the specific voltages described or depicted herein, are intended as examples of one possible embodiment. Other embodiments may include voltages (e.g., REF1 or REF2 of 425, the specific values of Rd, Ra, or Rp, etc.) that are different than those shown. Additionally, as previously noted, in other embodiments the specific circuits or depicted devices/lines/accessories may include more or fewer elements than are depicted, elements arranged in a different order that still achieve a similar function as described, etc.

### Device Mode Implementation

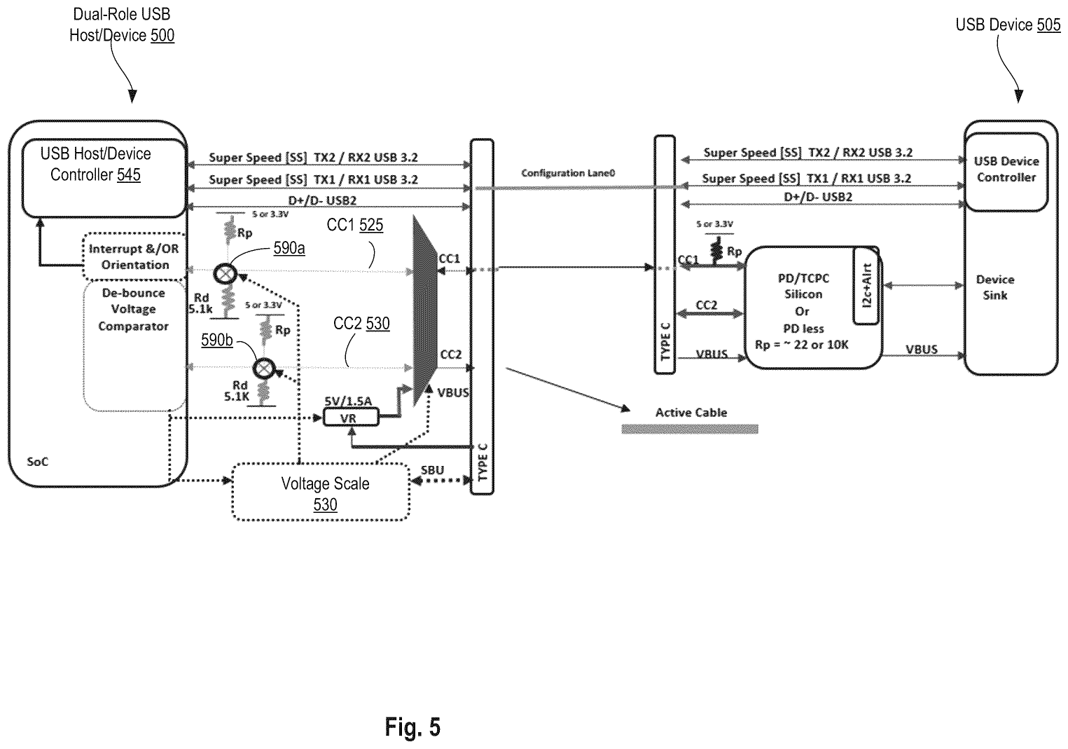

In some embodiments, it may be desirable for a PD/TCPC-less system to be enabled to serve as a USB host or a USB device. Such a system may be referred to as a “dual-role” system. FIG. 5 illustrates an alternative example of a system with a PD/TCPC-less USB 3.2 dual-role host or device SoC, in accordance with various embodiments.

Specifically FIG. 5 depicts a dual-role USB host/device system 500. In some embodiments, the USB host/device 500 may function as a host (e.g., one or more of USB hosts 100, 200, 300, etc.) Additionally, the USB host/device 500 may be configured to function as a device (e.g., one of USB devices 105, 205, 305, etc.). In some embodiments, whether the dual-role USB host/device system 500 functions as a host or a device may rely on previously input configuration settings. Such settings may be provided, for example, by a user of the dual-role USB host/device system 500 using an application programming interface (API) or by some other input.

To perform these functions (e.g., as a USB host or USB device), the dual-role USB host/device system 500 may include a USB host/device controller 545. The USB host/device controller 545 may, dependent on the previously-input settings, serve as a USB host controller (e.g., USB host controller 145) if the settings indicate that the dual-role USB host/device system 500 is to function as a USB host. Additionally, the USB host/device controller 545 may serve as a USB device controller (e.g., a USB controller of a USB device such as USB device 505) if the settings indicate that the dual-role USB host/device system 500 is to function as a USB device. It will be noted that, although the USB host/device controller 545 is depicted as a single element, in other embodiments the USB host/device controller 545 may be two separate elements that are communicatively coupled with one another, with the data lines, and/or with some other element of the dual-role USB host/device system 500.

In embodiments, the dual-role USB host/device system 500 may include one or more switches 590a and 590b as shown in FIG. 5, which may be respectively coupled with the CC lines 525/530 of the dual-role USB host/device system 500. The CC lines 525/530 may be similar to, for example, CC lines 125/130 of FIG. 1.

It will be noted that, in some embodiments, elements 590a and 590b may be selectable switches that are controlled by one or more state machine controllers (not shown) of the dual-role USB host/device system 500. In other embodiments, elements 590a and 590b may be considered to be separate state machines or may jointly make up a single state machine.

The switches 590a/590b may toggle between Rp and Rd to determine if an external connection may wish to serve as a USB host or a USB device. Specifically, if switches 590a/590b couple CC1 525 and CC2 530 to Rp, then the dual-role USB host/device system 500 may function in a host capacity. Alternatively, if switches 590a/590b couple CC1 525 and CC2 530 to Rd, then the dual-role USB host/device system 500 may function in a device capacity. As noted, the settings of the switches 590a/590b may be dependent on the previously input settings such as may be entered by a user through an API. It will be noted that, subsequent to the alteration to the state machine, the orientation identification may occur as indicated with respect to one or more of the previously-described techniques. Specifically, the orientation detection and subsequent configuration may occur without the use of a PD and/or TCPC module.

### Example Techniques

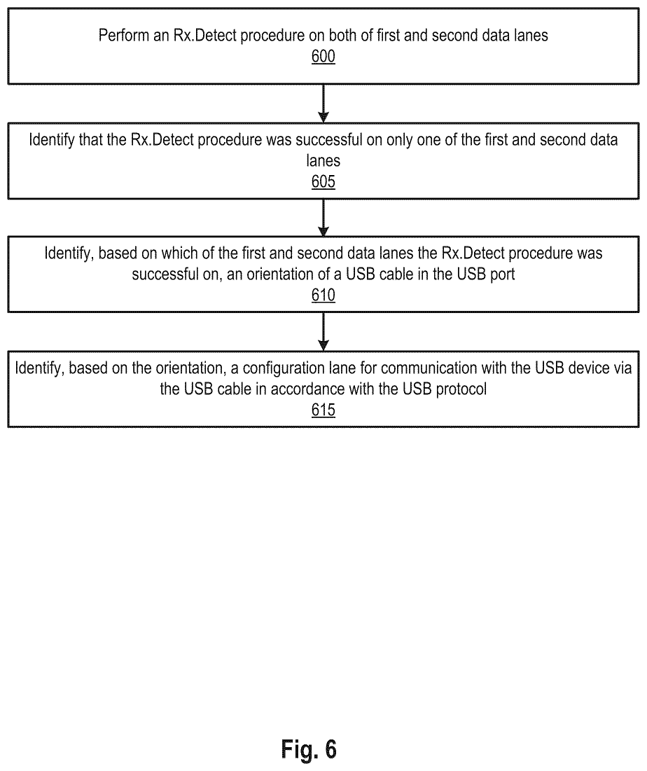

FIGS. 6, 7, and 9 illustrate example processes to be performed by a USB host, one or more elements of a USB host, and/or an electronic device that includes a USB host, in accordance with various embodiments. While the blocks are illustrated in a particular sequence, the sequence can be modified. For example, some blocks can be performed before others, while some blocks can be performed simultaneously with other blocks. In general, the techniques may be performed by a USB host controller of a USB host (e.g., the host controller 145 of FIG. 1). In some embodiments, at least portions of the described technique may be additionally or alternatively performed by a comparator module (e.g., module 135), while in other embodiments the technique may be performed by additional or alternative elements, processors, logic, etc.

FIG. 6 may relate to the first technique described above (e.g., the Rx.Detect related technique). The technique of FIG. 6 may performing, at 600, an Rx.Detect procedure on both of the first and second data lanes of a USB host. The Rx.Detect procedure may be performed as previously described with respect to data lanes 120/123 of USB host 100 in FIG. 1.

The technique may further include identifying, at 605, that the Rx.Detect procedure was successful on only one of the first and second data lanes. For example, based on the orientation of the cable in the port of the USB host, only one of the data lanes may be exposed during the Rx.Detect procedure. As such, even though the procedure is performed on both lanes, it may only be successful on one of the two data lanes.

The technique may further include identifying, at 610 based on which of the first and second data lanes the Rx.Detect procedure was successful on, an orientation of a USB cable in the USB port. Specifically, if the cable is oriented in the port in one direction, then the Rx.Detect procedure may be successful on the first data lane. If the cable is oriented in the other direction, then the Rx.Detect procedure may be successful on the other data lane. The technique may then include identifying, at 615 based on the orientation, a configuration lane (e.g., configuration lane 115) for communication with the USB device (e.g., USB device 105) in accordance with the USB protocol (e.g., USB 3.2).

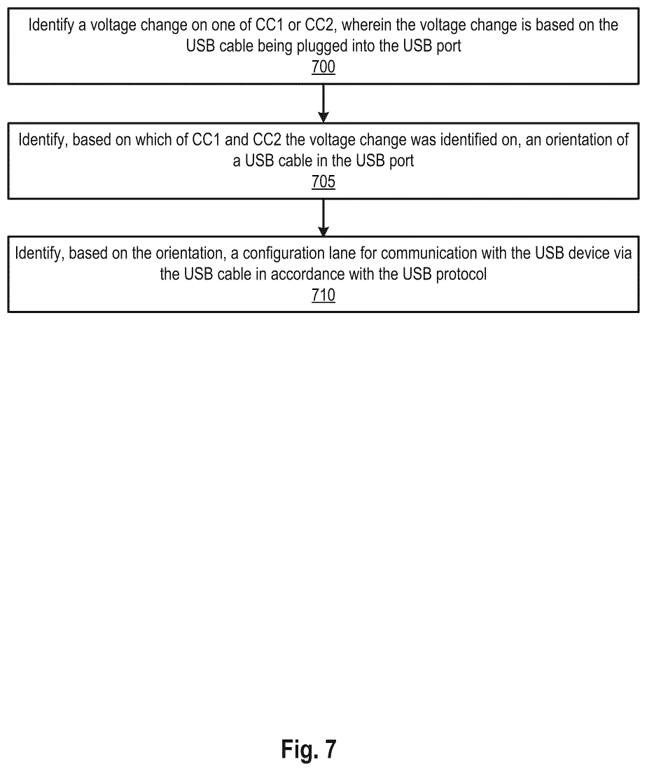

FIG. 7 may relate to the second technique described above (e.g., the voltage change technique). The technique may include identifying, at 700, a voltage change on one of CC1 or CC2 (e.g., CC1 225 or CC2 230 of FIG. 2), wherein the voltage change is based on a USB cable being plugged into the USB port. As previously described, dependent on the orientation of the cable, a CC connection 250 may only be made with one of the device CCs 245, and therefore the voltage change would only be detected on one of CC1 225 and CC2 230.

The technique may further include identifying, at 705 based on which of CC1 and CC2 the voltage change was identified on, an orientation of a USB cable in the USB port. The technique may further include identifying, at 710 based on the orientation, a configuration lane (e.g., configuration lane 115) for communication with the USB device (e.g., USB device 205) in accordance with a USB protocol (e.g., USB 3.2).

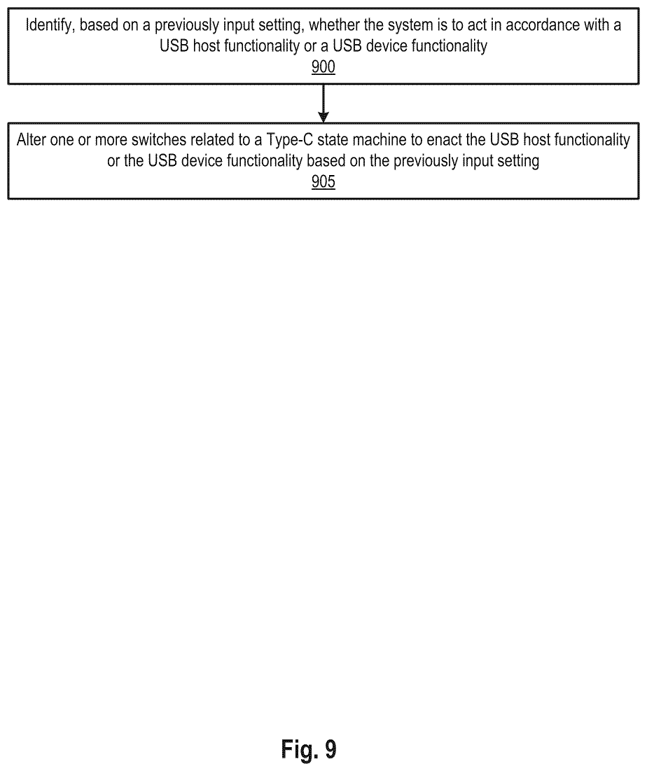

FIG. 9 illustrates an example process to be performed by a dual-role USB 3.2 host/device system, one or more elements of such a system, and/or an electronic device that includes such a system, in accordance with various embodiments. The technique may include identifying, at 900 based on a previously input setting (e.g., such as may be input by a user through an API or some other setting), whether the system (e.g., system 500) is to act in accordance with a USB host functionality or a USb device functionality. The technique may further include altering, at 905, one or more switches (e.g., switches 590a and 590b) related to a Type-C state machine to enact the USB host functionality or the USB device functionality based on the previously input setting. The flowchart of FIGS. 6, 7, and/or 9 can be performed partially or wholly by software providing in a machine-readable storage medium (e.g., memory). The software is stored as computer-executable instructions (e.g., instructions to implement any other processes discussed herein). Program software code/instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart (and/or various embodiments) are executed by the processor system.

In some embodiments, the program software code/instructions associated with the flowchart (and/or various embodiments) are stored in a computer executable storage medium and executed by the processor. Here, the computer executable storage medium is a tangible machine readable medium that can be used to store program software code/instructions and data that, when executed by a computing device, causes one or more processors to perform a method(s) as may be recited in one or more accompanying claims directed to the disclosed subject matter.

The tangible machine-readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions (associated with the flowchart and other embodiments) and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of the tangible computer-readable media include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium includes any tangible mechanism that provides (e.g., stores and/or transmits in digital form, e.g., data packets) information in a form accessible by a machine (e.g., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

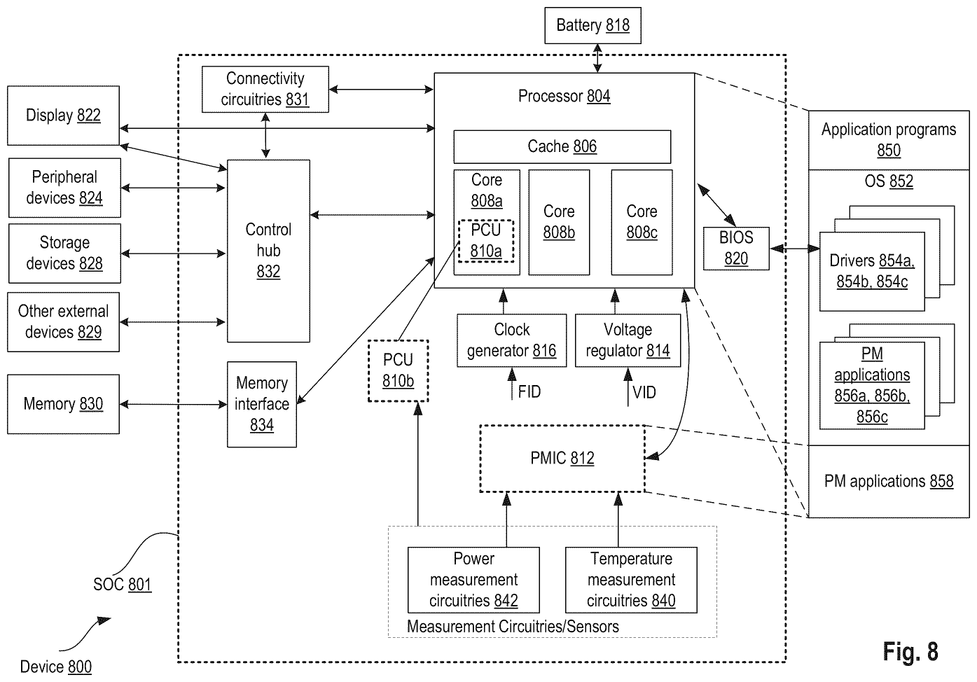

FIG. 8 illustrates a smart device or a computer system or a System-on-Chip (SoC) with apparatus and/or software for PD/TCPC-less operation of a USB host, a dual-role system, or some other electronic device, in accordance with some embodiments. In some embodiments the electronic device 800 may be, include, or be part of a USB host such as one of devices 100/200/300/etc., and/or a dual-role system such as system 500.

In some embodiments, device 800 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 800. The apparatus and/or software for controlling wake sources in a system to reduce power consumption in sleep state can be in the wireless connectivity circuitries 831, PCU 810, and/or other logic blocks (e.g., operating system 852) that can manage power for the computer system.

In an example, the device 800 comprises an SoC (System-on-Chip) 801. An example boundary of the SoC 801 is illustrated using dotted lines in FIG. 8, with some example components being illustrated to be included within SoC 801—however, SoC 801 may include any appropriate components of device 800.

In some embodiments, device 800 includes processor 804. Processor 804 can include one or more physical devices, such as microprocessors, application processors, microcontrollers, programmable logic devices, processing cores, or other processing means. The processing operations performed by processor 804 include the execution of an operating platform or operating system on which applications and/or device functions are executed. The processing operations include operations related to I/O (input/output) with a human user or with other devices, operations related to power management, operations related to connecting computing device 800 to another device, and/or the like. The processing operations may also include operations related to audio I/O and/or display I/O.

In some embodiments, processor 804 includes multiple processing cores (also referred to as cores) 808a, 808b, 808c. Although merely three cores 808a, 808b, 808c are illustrated in FIG. 8, processor 804 may include any other appropriate number of processing cores, e.g., tens, or even hundreds of processing cores. Processor cores 808a, 808b, 808c may be implemented on a single integrated circuit (IC) chip. Moreover, the chip may include one or more shared and/or private caches, buses or interconnections, graphics and/or memory controllers, or other components.

In some embodiments, processor 804 includes cache 806. In an example, sections of cache 806 may be dedicated to individual cores 808 (e.g., a first section of cache 806 dedicated to core 808a, a second section of cache 806 dedicated to core 808b, and so on). In an example, one or more sections of cache 806 may be shared among two or more of cores 808. Cache 806 may be split in different levels, e.g., level 1 (L1) cache, level 2 (L2) cache, level 3 (L3) cache, etc.

In some embodiments, processor core 804 may include a fetch unit to fetch instructions (including instructions with conditional branches) for execution by the core 804. The instructions may be fetched from any storage devices such as the memory 830. Processor core 804 may also include a decode unit to decode the fetched instruction. For example, the decode unit may decode the fetched instruction into a plurality of micro-operations. Processor core 804 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 804 may be an out-of-order processor core in one embodiment. Processor core 804 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 804 may also include a bus unit to enable communication between components of processor core 804 and other components via one or more buses. Processor core 804 may also include one or more registers to store data accessed by various components of the core 804 (such as values related to assigned app priorities and/or sub-system states (modes) association.

In some embodiments, device 800 comprises connectivity circuitries 831. For example, connectivity circuitries 831 includes hardware devices (e.g., wireless and/or wired connectors and communication hardware) and/or software components (e.g., drivers, protocol stacks), e.g., to enable device 800 to communicate with external devices. Device 800 may be separate from the external devices, such as other computing devices, wireless access points or base stations, etc.

In an example, connectivity circuitries 831 may include multiple different types of connectivity. To generalize, the connectivity circuitries 831 may include cellular connectivity circuitries, wireless connectivity circuitries, etc. Cellular connectivity circuitries of connectivity circuitries 831 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 831 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 831 may include a network interface, such as a wired or wireless interface, e.g., so that a system embodiment may be incorporated into a wireless device, for example, a cell phone or personal digital assistant.

In some embodiments, device 800 comprises control hub 832, which represents hardware devices and/or software components related to interaction with one or more I/O devices. For example, processor 804 may communicate with one or more of display 822, one or more peripheral devices 824, storage devices 828, one or more other external devices 829, etc., via control hub 832. Control hub 832 may be a chipset, a Platform Control Hub (PCH), and/or the like. Such a peripheral device 824 may be or include any one or more of the USB device(s) 105/205/305, an active cable 310, an audio accessory 315, a debug accessory 320, etc. The control hub 832 may be or include, for example, a USB host controller such as host controller 145.

For example, control hub 832 illustrates one or more connection points for additional devices that connect to device 800, e.g., through which a user might interact with the system. For example, devices (e.g., devices 829) that can be attached to device 800 include microphone devices, speaker or stereo systems, audio devices, video systems or other display devices, keyboard or keypad devices, or other I/O devices for use with specific applications such as card readers or other devices.

As mentioned above, control hub 832 can interact with audio devices, display 822, etc. For example, input through a microphone or other audio device can provide input or commands for one or more applications or functions of device 800. Additionally, audio output can be provided instead of, or in addition to display output. In another example, if display 822 includes a touch screen, display 822 also acts as an input device, which can be at least partially managed by control hub 832. There can also be additional buttons or switches on computing device 800 to provide I/O functions managed by control hub 832. In one embodiment, control hub 832 manages devices such as accelerometers, cameras, light sensors or other environmental sensors, or other hardware that can be included in device 800. The input can be part of direct user interaction, as well as providing environmental input to the system to influence its operations (such as filtering for noise, adjusting displays for brightness detection, applying a flash for a camera, or other features).

In some embodiments, control hub 832 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 822 represents hardware (e.g., display devices) and software (e.g., drivers) components that provide a visual and/or tactile display for a user to interact with device 800. Display 822 may include a display interface, a display screen, and/or hardware device used to provide a display to a user. In some embodiments, display 822 includes a touch screen (or touch pad) device that provides both output and input to a user. In an example, display 822 may communicate directly with the processor 804. Display 822 can be one or more of an internal display device, as in a mobile electronic device or a laptop device or an external display device attached via a display interface (e.g., DisplayPort, etc.). In one embodiment display 822 can be a head mounted display (HMD) such as a stereoscopic display device for use in virtual reality (VR) applications or augmented reality (AR) applications.

In some embodiments, and although not illustrated in the figure, in addition to (or instead of) processor 804, device 800 may include Graphics Processing Unit (GPU) comprising one or more graphics processing cores, which may control one or more aspects of displaying contents on display 822.

Control hub 832 (or platform controller hub) may include hardware interfaces and connectors, as well as software components (e.g., drivers, protocol stacks) to make peripheral connections, e.g., to peripheral devices 824.

It will be understood that device 800 could both be a peripheral device to other computing devices, as well as have peripheral devices connected to it. Device 800 may have a “docking” connector to connect to other computing devices for purposes such as managing (e.g., downloading and/or uploading, changing, synchronizing) content on device 800. Additionally, a docking connector can allow device 800 to connect to certain peripherals that allow computing device 800 to control content output, for example, to audiovisual or other systems.

In addition to a proprietary docking connector or other proprietary connection hardware, device 800 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 831 may be coupled to control hub 832, e.g., in addition to, or instead of, being coupled directly to the processor 804. In some embodiments, display 822 may be coupled to control hub 832, e.g., in addition to, or instead of, being coupled directly to processor 804.

In some embodiments, device 800 comprises memory 830 coupled to processor 804 via memory interface 834. Memory 830 includes memory devices for storing information in device 800.

In some embodiments, memory 830 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 830 can be a dynamic random-access memory (DRAM) device, a static random-access memory (SRAM) device, flash memory device, phase-change memory device, or some other memory device having suitable performance to serve as process memory. In one embodiment, memory 830 can operate as system memory for device 800, to store data and instructions for use when the one or more processors 804 executes an application or process. Memory 830 can store application data, user data, music, photos, documents, or other data, as well as system data (whether long-term or temporary) related to the execution of the applications and functions of device 800.

Elements of various embodiments and examples are also provided as a machine-readable medium (e.g., memory 830) for storing the computer-executable instructions (e.g., instructions to implement any other processes discussed herein). The machine-readable medium (e.g., memory 830) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 800 comprises temperature measurement circuitries 840, e.g., for measuring temperature of various components of device 800. In an example, temperature measurement circuitries 840 may be embedded, or coupled or attached to various components, whose temperature are to be measured and monitored. For example, temperature measurement circuitries 840 may measure temperature of (or within) one or more of cores 808a, 808b, 808c, voltage regulator 814, memory 830, a mother-board of SoC 801, and/or any appropriate component of device 800.

In some embodiments, device 800 comprises power measurement circuitries 842, e.g., for measuring power consumed by one or more components of the device 800. In an example, in addition to, or instead of, measuring power, the power measurement circuitries 842 may measure voltage and/or current. In an example, the power measurement circuitries 842 may be embedded, or coupled or attached to various components, whose power, voltage, and/or current consumption are to be measured and monitored. For example, power measurement circuitries 842 may measure power, current and/or voltage supplied by one or more voltage regulators 814, power supplied to SoC 801, power supplied to device 800, power consumed by processor 804 (or any other component) of device 800, etc.

In some embodiments, device 800 comprises one or more voltage regulator circuitries, generally referred to as voltage regulator (VR) 814. VR 814 generates signals at appropriate voltage levels, which may be supplied to operate any appropriate components of the device 800. Merely as an example, VR 814 is illustrated to be supplying signals to processor 804 of device 800. In some embodiments, VR 814 receives one or more Voltage Identification (VID) signals, and generates the voltage signal at an appropriate level, based on the VID signals. Various type of VRs may be utilized for the VR 814. For example, VR 814 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 810a/b and/or PMIC 812. In some embodiments, each core has a network of distributed LDOs to provide efficient control for power management. The LDOs can be digital, analog, or a combination of digital or analog LDOs. In some embodiments, VR 814 includes current tracking apparatus to measure current through power supply rail(s).

In some embodiments, device 800 comprises one or more clock generator circuitries, generally referred to as clock generator 816. Clock generator 816 generates clock signals at appropriate frequency levels, which may be supplied to any appropriate components of device 800. Merely as an example, clock generator 816 is illustrated to be supplying clock signals to processor 804 of device 800. In some embodiments, clock generator 816 receives one or more Frequency Identification (FID) signals, and generates the clock signals at an appropriate frequency, based on the FID signals.

In some embodiments, device 800 comprises battery 818 supplying power to various components of device 800. Merely as an example, battery 818 is illustrated to be supplying power to processor 804. Although not illustrated in the figures, device 800 may comprise a charging circuitry, e.g., to recharge the battery, based on Alternating Current (AC) power supply received from an AC adapter.

In some embodiments, device 800 comprises Power Control Unit (PCU) 810 (also referred to as Power Management Unit (PMU), Power Controller, etc.). In an example, some sections of PCU 810 may be implemented by one or more processing cores 808, and these sections of PCU 810 are symbolically illustrated using a dotted box and labelled PCU 810a. In an example, some other sections of PCU 810 may be implemented outside the processing cores 808, and these sections of PCU 810 are symbolically illustrated using a dotted box and labelled as PCU 810b. PCU 810 may implement various power management operations for device 800. PCU 810 may include hardware interfaces, hardware circuitries, connectors, registers, etc., as well as software components (e.g., drivers, protocol stacks), to implement various power management operations for device 800.

In some embodiments, device 800 comprises Power Management Integrated Circuit (PMIC) 812, e.g., to implement various power management operations for device 800. In some embodiments, PMIC 812 is a Reconfigurable Power Management ICs (RPMICs) and/or an IMVP (Intel® Mobile Voltage Positioning). In an example, the PMIC is within an IC chip separate from processor 804. The may implement various power management operations for device 800. PMIC 812 may include hardware interfaces, hardware circuitries, connectors, registers, etc., as well as software components (e.g., drivers, protocol stacks), to implement various power management operations for device 800.

In an example, device 800 comprises one or both PCU 810 or PMIC 812. In an example, any one of PCU 810 or PMIC 812 may be absent in device 800, and hence, these components are illustrated using dotted lines.

Various power management operations of device 800 may be performed by PCU 810, by PMIC 812, or by a combination of PCU 810 and PMIC 812. For example, PCU 810 and/or PMIC 812 may select a power state (e.g., P-state) for various components of device 800. For example, PCU 810 and/or PMIC 812 may select a power state (e.g., in accordance with the ACPI (Advanced Configuration and Power Interface) specification) for various components of device 800. Merely as an example, PCU 810 and/or PMIC 812 may cause various components of the device 800 to transition to a sleep state, to an active state, to an appropriate C state (e.g., CO state, or another appropriate C state, in accordance with the ACPI specification), etc. In an example, PCU 810 and/or PMIC 812 may control a voltage output by VR 814 and/or a frequency of a clock signal output by the clock generator, e.g., by outputting the VID signal and/or the FID signal, respectively. In an example, PCU 810 and/or PMIC 812 may control battery power usage, charging of battery 818, and features related to power saving operation.

The clock generator 816 can comprise a phase locked loop (PLL), frequency locked loop (FLL), or any suitable clock source. In some embodiments, each core of processor 804 has its own clock source. As such, each core can operate at a frequency independent of the frequency of operation of the other core. In some embodiments, PCU 810 and/or PMIC 812 performs adaptive or dynamic frequency scaling or adjustment. For example, clock frequency of a processor core can be increased if the core is not operating at its maximum power consumption threshold or limit. In some embodiments, PCU 810 and/or PMIC 812 determines the operating condition of each core of a processor, and opportunistically adjusts frequency and/or power supply voltage of that core without the core clocking source (e.g., PLL of that core) losing lock when the PCU 810 and/or PMIC 812 determines that the core is operating below a target performance level. For example, if a core is drawing current from a power supply rail less than a total current allocated for that core or processor 804, then PCU 810 and/or PMIC 812 can temporality increase the power draw for that core or processor 804 (e.g., by increasing clock frequency and/or power supply voltage level) so that the core or processor 804 can perform at higher performance level. As such, voltage and/or frequency can be increased temporality for processor 804 without violating product reliability.

In an example, PCU 810 and/or PMIC 812 may perform power management operations, e.g., based at least in part on receiving measurements from power measurement circuitries 842, temperature measurement circuitries 840, charge level of battery 818, and/or any other appropriate information that may be used for power management. To that end, PMIC 812 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 810 and/or PMIC 812 in at least one embodiment to allow PCU 810 and/or PMIC 812 to manage processor core energy at least in part based on value(s) detected by one or more of the sensors.

Also illustrated is an example software stack of device 800 (although not all elements of the software stack are illustrated). Merely as an example, processors 804 may execute application programs 850, Operating System 852, one or more Power Management (PM) specific application programs (e.g., generically referred to as PM applications 858), and/or the like. PM applications 858 may also be executed by the PCU 810 and/or PMIC 812. OS 852 may also include one or more PM applications 856a, 856b, 856c. The OS 852 may also include various drivers 854a, 854b, 854c, etc., some of which may be specific for power management purposes. In some embodiments, device 800 may further comprise a Basic Input/output System (BIOS) 820. BIOS 820 may communicate with OS 852 (e.g., via one or more drivers 854), communicate with processors 804, etc.

For example, one or more of PM applications 858, 856, drivers 854, BIOS 820, etc. may be used to implement power management specific tasks, e.g., to control voltage and/or frequency of various components of device 800, to control wake-up state, sleep state, and/or any other appropriate power state of various components of device 800, control battery power usage, charging of the battery 818, features related to power saving operation, etc.

In some embodiments, battery 818 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, pCode executing on PCU 810a/b has a capability to enable extra compute and telemetries resources for the runtime support of the pCode. Here pCode refers to a firmware executed by PCU 810a/b to manage performance of the SoC 801. For example, pCode may set frequencies and appropriate voltages for the processor. Part of the pCode are accessible via OS 852. In various embodiments, mechanisms and methods are provided that dynamically change an Energy Performance Preference (EPP) value based on workloads, user behavior, and/or system conditions. There may be a well-defined interface between OS 852 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 852 by including machine-learning support as part of OS 852 and either tuning the EPP value that the OS hints to the hardware (e.g., various components of SoC 801) by machine-learning prediction, or by delivering the machine-learning prediction to the pCode in a manner similar to that done by a Dynamic Tuning Technology (DTT) driver. In this model, OS 852 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 852 and the other from software such as DTT, and may selectively choose to provide higher performance and/or responsiveness. As part of this method, the pCode may enable in the DTT an option to tune its reaction for the DTT for different types of activity.

Some non-limiting Examples of various embodiments are presented below.

Example 1 includes a universal serial bus (USB) host comprising: a USB port to couple with a USB device by a USB cable and communicate with the USB device in accordance with a USB protocol; and a USB host controller communicatively coupled with the USB port by a first data lane and a second data lane, wherein the USB host controller is to: perform an Rx.Detect procedure on both of the first and second data lanes; identify that the Rx.Detect procedure was successful on only one of the first and second data lanes; identify, based on which of the first and second data lanes the Rx.Detect procedure was successful on, an orientation of a USB cable in the USB port; and identify, based on the orientation, a configuration lane for communication with the USB device via the USB cable in accordance with the USB protocol.

Example 2 include the USB host of example 1, and/or some other example herein, wherein the USB host controller is further to: identify, if the Rx.Detect procedure is successful on the first data lane, the first data lane as the configuration lane; and identify, if the Rx.Detect procedure is successful on the second data lane, the second data lane as the configuration lane.

Example 3 include the USB host of any of examples 1-2, and/or some other example herein, wherein the USB protocol is a USB 3.2 protocol.

Example 4 include the USB host of any of examples 1-3, and/or some other example herein, wherein the USB port is a USB Type-C port.

Example 5 include the USB host of any of examples 1-4, and/or some other example herein, wherein the USB host controller is further communicatively coupled with the USB port by at least two data lanes.

Example 6 include the USB host of any of examples 1-5, and/or some other example herein, wherein the Rx.Detect procedure is performed without a power delivery (PD) controller or a type-C port controller (TCPC).

Example 7 include the USB host of any of examples 1-6, and/or some other example herein, wherein the USB host further includes a first communication channel (CC1) and a second communication channel (CC2) coupled with the USB port, wherein CC1 and CC2 are different from the first and second data lanes.

Example 8 includes the USB host of example 7, and/or some other example herein, wherein CC1 and CC2 are electrically coupled to a voltage pull-up.

Example 9 includes the USB host of any of examples 1-8, and/or some other example herein, wherein the USB host controller is further to perform the Rx.Detect procedure subsequent to a reset procedure.

Example 10 includes the USB host of example 9, and/or some other example herein, wherein the USB host controller is further to trigger VBus in the USB port prior to performing the RX.Detect procedure.

Example 11 includes a universal serial bus (USB) host comprising: a USB port to couple with a USB device by a USB cable and communicate with the USB device in accordance with a USB protocol; and a USB host controller communicatively coupled with the USB port by a first configuration channel (CC1) and a second configuration channel (CC2), wherein the USB host controller is to: identify a voltage change on one of CC1 or CC2, wherein the voltage change is based on the USB cable being plugged into the USB port; identify, based on which of CC1 and CC2 the voltage change was identified on, an orientation of a USB cable in the USB port; and identify, based on the orientation, a configuration lane for communication with the USB device via the USB cable in accordance with the USB protocol.

Example 12 includes the USB host of example 11, and/or some other example herein, wherein the voltage change is based on a voltage provided by the USB device to the USB cable.

Example 13 includes the USB host of any of examples 11-12, and/or some other example herein, wherein the USB host controller is further to identify, based which of CC1 and CC2 the voltage change was identified on, CC1 or CC2 as the configuration lane.

Example 14 includes the USB host of any of examples 11-13, and/or some other example herein, wherein the USB protocol is a USB 3.2 protocol.

Example 15 includes the USB host of any of examples 11-14, and/or some other example herein, wherein the USB port is a USB Type-C port.

Example 16 includes the USB host of any of examples 11-15, and/or some other example herein, wherein the USB host controller is further communicatively coupled with the USB port by a first data lane and a second data lane.

Example 17 includes the USB host of example 16, wherein: if the voltage change is identified on CC1, the USB host controller is to identify the first data lane as the configuration lane; and if the voltage change is identified on CC2, the USB host controller is to identify the second data lane as the configuration lane.

Example 18 includes the USB host of any of examples 11-17, and/or some other example herein, wherein the identification of the voltage change is performed without a power delivery (PD) controller or a type-C port controller (TCPC).

Example 19 includes a universal serial bus (USB) system comprising: a USB port to couple with another electronic device by a USB cable and communicate with the other electronic device in accordance with a USB protocol; and a USB host/device controller communicatively coupled with the USB port by a first data lane, a second data lane, a first communication channel (CC), and a second CC, wherein the USB host/device controller is to: identify, based on a previously input setting, whether the system is to act in accordance with a USB host functionality or a USB device functionality; and alter one or more switches related to a Type-C state machine to enact the USB host functionality or the USB device functionality based on the previously input setting.

Example 20 includes the USB system of example 19, and/or some other example herein, wherein alteration of the switches changes to which of a device-related resistor and host-related resistor the first CC and the second CC are coupled.

Example 21 includes the USB system of example 20, and/or some other example herein, wherein, if the system is to act in accordance with a USB host functionality, the first and second CC are coupled with one or more Rp resistors.

Example 22 includes the USB system of example 20, and/or some other example herein, wherein, if the system is to act in accordance with a USB device functionality, the first and second CC are coupled with one or more Rd resistors.

Example 23 includes the USB system of any of examples 19-22, and/or some other example herein, wherein, if the system is to act in accordance with the USB host functionality, the USB host/device controller is further to: identify a voltage change on one of the first CC or the second CC, wherein the voltage change is based on the USB cable being plugged into the USB port; identify, based on which of the first CC and the second CC the voltage change was identified on, an orientation of a USB cable in the USB port; and identify, based on the orientation, a configuration lane for communication with the USB device via the USB cable in accordance with the USB protocol.

Example 24 includes the USB system of any of examples 19-23, and/or some other example herein, wherein, if the system is to act in accordance with the USB host functionality, the USB host/device controller is further to: perform an Rx.Detect procedure on both of the first and second data lanes; identify that the Rx.Detect procedure was successful on only one of the first and second data lanes; identify, based on which of the first and second data lanes the Rx.Detect procedure was successful on, an orientation of a USB cable in the USB port; and identify, based on the orientation, a configuration lane for communication with the USB device via the USB cable in accordance with the USB protocol.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. A universal serial bus (USB) host comprising:
a USB port to couple with a USB device by a USB cable and communicate with the USB device in accordance with a USB protocol; and
a USB host controller communicatively coupled with the USB port by a first data lane and a second data lane, wherein the USB host controller is to:
perform an Rx.Detect procedure on both of the first and second data lanes;
identify that the Rx.Detect procedure was successful on only one of the first and second data lanes;
identify, based on which of the first and second data lanes the Rx.Detect procedure was successful on, an orientation of a USB cable in the USB port; and
identify, based on the orientation, a configuration lane for communication with the USB device via the USB cable in accordance with the USB protocol.

2. The USB host of claim 1, wherein the USB host controller is further to:
identify, if the Rx.Detect procedure is successful on the first data lane, the first data lane as the configuration lane; and
identify, if the Rx.Detect procedure is successful on the second data lane, the second data lane as the configuration lane.

3. The USB host of claim 1, wherein the USB protocol is a USB 3.2 protocol.

4. The USB host of claim 1, wherein the USB port is a USB Type-C port.

5. The USB host of claim 1, wherein the USB host controller is further communicatively coupled with the USB port by at least two data lanes.

6. The USB host of claim 1, wherein the Rx.Detect procedure is performed without a power delivery (PD) controller or a type-C port controller (TCPC).

7. The USB host of claim 1, wherein the USB host further includes a first communication channel (CC1) and a second communication channel (CC2) coupled with the USB port, wherein CC1 and CC2 are different from the first and second data lanes.

8. The USB host of claim 1, wherein the USB host controller is further to perform the Rx.Detect procedure subsequent to a reset procedure.

9. A universal serial bus (USB) host comprising:
a USB port to couple with a USB device by a USB cable and communicate with the USB device in accordance with a USB protocol; and
a USB host controller communicatively coupled with the USB port by a first configuration channel (CC1) and a second configuration channel (CC2), wherein the USB host controller is to:
identify a voltage change on one of CC1 or CC2, wherein the voltage change is based on the USB cable being plugged into the USB port;
identify, based on which of CC1 and CC2 the voltage change was identified on, an orientation of a USB cable in the USB port; and
identify, based on the orientation, a configuration lane for communication with the USB device via the USB cable in accordance with the USB protocol.

10. The USB host of claim 9, wherein the voltage change is based on a voltage provided by the USB device to the USB cable.

11. The USB host of claim 9, wherein the USB host controller is further to identify, based which of CC1 and CC2 the voltage change was identified on, CC1 or CC2 as the configuration lane.

12. The USB host of claim 9, wherein the USB protocol is a USB 3.2 protocol.

13. The USB host of claim 9, wherein the USB port is a USB Type-C port.

14. The USB host of claim 9, wherein the USB host controller is further communicatively coupled with the USB port by a first data lane and a second data lane.

15. The USB host of claim 14, wherein:
if the voltage change is identified on CC1, the USB host controller is to identify the first data lane as the configuration lane; and
if the voltage change is identified on CC2, the USB host controller is to identify the second data lane as the configuration lane.

16. The USB host of claim 9, wherein the identification of the voltage change is performed without a power delivery (PD) controller or a type-C port controller (TCPC).

17. A universal serial bus (USB) system comprising:
a USB port to couple with another electronic device by a USB cable and communicate with the other electronic device in accordance with a USB protocol; and
a USB host/device controller communicatively coupled with the USB port by a first data lane, a second data lane, a first communication channel (CC), and a second CC, wherein the USB host/device controller is to:
identify, based on a previously input setting, whether the system is to act in accordance with a USB host functionality or a USB device functionality; and
alter one or more switches related to a Type-C state machine to enact the USB host functionality or the USB device functionality based on the previously input setting.

18. The USB system of claim 17, wherein alteration of the switches changes to which of a device-related resistor and host-related resistor the first CC and the second CC are coupled.

19. The USB system of claim 17, wherein, if the system is to act in accordance with the USB host functionality, the USB host/device controller is further to:
identify a voltage change on one of the first CC or the second CC, wherein the voltage change is based on the USB cable being plugged into the USB port;
identify, based on which of the first CC and the second CC the voltage change was identified on, an orientation of a USB cable in the USB port; and
identify, based on the orientation, a configuration lane for communication with the USB device via the USB cable in accordance with the USB protocol.

20. The USB system of claim 17, wherein, if the system is to act in accordance with the USB host functionality, the USB host/device controller is further to:
perform an Rx.Detect procedure on both of the first and second data lanes;
identify that the Rx.Detect procedure was successful on only one of the first and second data lanes;
identify, based on which of the first and second data lanes the Rx.Detect procedure was successful on, an orientation of a USB cable in the USB port; and
identify, based on the orientation, a configuration lane for communication with the USB device via the USB cable in accordance with the USB protocol.
